(19) United States
(12) Patent Application Publication
(10) Pub. No.: US 2026/0209509 A1
(43) Pub. Date: Jul. 23, 2026

(54) POLYLACTIDE RESIN COMPOSITIONS AND BIAXIAL STRETCHING PROCESS FOR THE POLYLACTIDE RESIN COMPOSITIONS

(71) Applicant: NatureWorks LLC, Plymouth, MN (US)

(72) Inventors: Krag Ellis Anderson, Fridley, MN (US); Osei A. Owusu, Plymouth, MN (US); Jed Richard Randall, Minneapolis, MN (US); Joseph David Schroeder, Minneapolis, MN (US); James Russell Valentine, Chanhassen, MN (US); Timothy J. Vanyo, Crystal, MN (US); Deepak P. Venkatraman, Plymouth, MN (US)

(21) Appl. No.: 19/144,209

(22) PCT Filed: Dec. 20, 2023
(86) PCT No.: PCT/US2023/085216

§ 371 Date: Jun. 27, 2025

Related U.S. Application Data
(60) Provisional application No. 63/435,596, filed on Dec. 28, 2022.

(51) Int. Cl. C08L 67/04; B29C 48/00; B29C 48/08; B29C 48/10; B29C 48/88; B29K 67/00; B29K 105/00; B29L 7/00; B29L 23/00; C08J 5/18

(52) U.S. Cl. CPC C08L 67/04; B29C 48/0018; B29C 48/022; B29C 48/08; B29C 48/10; B29C 48/912; C08J 5/18; B29K 2067/046; B29K 2105/0088; B29L 2007/008; B29L 2023/001; C08J 2367/04; C08J 2467/04; C08L 2203/16; C08L 2205/025

(57) ABSTRACT

Polylactide resin compositions include a mixture of 40 to 95 weight percent of a crystallizable polylactide resin and 5 to 60 weight percent of a certain non-crystallizable polylactide resin. The polylactide resin compositions are useful in making oriented film, especially biaxially oriented film. The compositions can be stretched on commercially available biaxial stretching equipment due to their ability to be stretched to higher stretch ratios than sheets made from the crystallizable polylactide resin alone.

This invention relates to polylactide resin compositions and methods for making oriented films from polylactide resin compositions.

Oriented polymer films are manufactured in large quantities for use as flexible packaging materials, particularly when properties such as optical clarity, moisture resistance and high tensile strength are required. Biaxially oriented films are used for packaging many food, beverage, medical, and personal care products, as well as many other uses. Such films are made by producing a sheet which is then stretched to produce the final film.

Polylactides (also known as polylactic acid, or PLA) can be used in these applications, but their penetration into these markets is limited because PLA sheets cannot be drawn to high stretch ratios, particularly when biaxially stretched. Most commonly available, industrial scale biaxial stretching equipment operates at stretch ratios of 3-5 in the machine direction and 4-10 in the transverse direction. PLA sheets have not been able to be stretched to these ratios without rupturing, so most commonly available biaxial stretching equipment cannot be used to process PLA into biaxially stretched film without modification. This has restricted the penetration of PLA into this market greatly, as oriented film manufacturers have invested already in equipment that must operate at this high stretch ratios and is not easily adapted to operate at lower ratios. A polylactide composition that can be stretched to higher stretch ratios while maintaining other useful characteristics, such as the ability to be oriented while producing a film having acceptable mechanical properties, would be desired, as would a method for producing PLA biaxially oriented films at higher stretch ratios.

This invention is a polylactide resin composition comprising a melt- or solution-blend of
(i) 40 to 95 weight percent based on the weight of all polylactides in the composition, of a crystallizable polylactide having a number-average molecular weight as measured by gel permeation chromatography against a polystyrene standard of at least 5000 g/mol and containing at least 90% by weight lactic units, wherein the lactic units are L-lactic units and D-lactic units in a ratio of ≥93:7 or ≤7:93 and (ii) 60 to 5 weight percent based on the weight of all polylactides in the composition of a non-crystallizable polylactide having a number-average molecular weight as measured by gel permeation chromatography against a polystyrene standard of at least 5000 g/mol and containing at least 90% by weight lactic units, wherein the lactic units are L-lactic units and D-lactic units in a ratio of ≥20:80 or ≤80:20.

FIG. 1 is an atomic force micrograph of a polylactide resin composition of the invention (Example 5).

FIG. 2 is an atomic force micrograph of a second polylactide resin composition of the invention.

Surprisingly, the polylactide resin composition of the invention is capable of being stretched to higher stretch ratios than the crystallizable polylactide by itself. Because of this, it can be processed on a wider variety of industrial-scale biaxial stretching equipment than can conventional polylactide resins. In many cases, this polylactide resin composition can be processed on existing polypropylene and PET biaxial stretching lines, with little or no modification to the equipment.

In some embodiments, the non-crystallizable polylactide grade is a poly(meso-lactide) which, for purposes of this invention, is a polymer or copolymer of meso-lactide in which at least 80% of the lactic units are incorporated by polymerizing meso-lactide, the poly(meso-lactide) having an average length of blocks of L-lactic units and of D-lactic units equal to at least 1.1 and up to 2.0. Polylactide resin compositions of the invention in which the amorphous polylactide grade is poly(meso-lactide) exhibit several unusual and beneficial characteristics. Surprisingly, it has been found that the crystallizable polylactide and the poly(meso-lactide) are immiscible in each other at these blend ratios. Accordingly, the melt- or solution blend of these polylactides is typically phase-segregated, with the crystallizable polylactide (i) occupying one phase and poly(meso-lactide) occupying a distinct phase within the blend. At higher contents of crystallizable polylactide (such as greater than about 50 wt.-% thereof, the crystallizable polylactide tends to form a continuous phase in which the poly(meso-lactide) is present as a discontinuous amorphous phase. At lower contents (such as about 50 wt.-% or less) of the crystallizable polylactide, the crystallizable polylactide and poly(meso-lactide) tend to form co-continuous phases, again with the poly(meso-lactide) phase being amorphous. The poly(meso-lactide) phase is incapable of being crystallized, and so remains amorphous even after the polylactide resin composition is stretched. The crystallizable polylactide phase, on the other hand, is capable of being crystallized, thermally and/or mechanically (as by stretching). This allows the blend to develop desirable thermal and physical properties associated with crystallization.

In another aspect, the invention is a process for producing an oriented polylactide film, comprising (a) forming a polylactide resin composition by melt- or solution-blending, the polylactide resin composition comprising
(i) 40 to 95 weight percent based on the weight of all polylactides in the composition, of a crystallizable polylactide having a number-average molecular weight as measured by gel permeation chromatography against a polystyrene standard of at least 5000 g/mol and containing at least 90% by weight lactic units, wherein the lactic units are L-lactic units and D-lactic units in a ratio of ≥93:7 or ≤7:93 and (ii) 60 to 5 weight percent based on the weight of all polylactides in the composition of a non-crystallizable polylactide having a number-average molecular weight as measured by gel permeation chromatography against a polystyrene standard of at least 5000 g/mol and containing at least 90% by weight lactic units, wherein the lactic units are L-lactic units and D-lactic units in a ratio of ≥20:80 or ≤80:20;
(b) extruding the polylactide resin composition through an extrusion die in a machine direction to produce a polylactide sheet, and
(c) stretching the sheet at a temperature of 50° C. to 120° C. to produce the oriented polylactide film.

In another aspect, the invention is a process for producing a biaxially oriented polylactide film, comprising (a) forming a polylactide resin composition by melt- or solution-blending, the polylactide resin composition comprising
(i) 40 to 95 weight percent based on the weight of all polylactides in the composition, of a crystallizable polylactide having a number-average molecular weight as measured by gel permeation chromatography against a polystyrene standard of at least 5000 g/mol and containing at least 90% by weight lactic units, wherein the lactic units are L-lactic units and D-lactic units in a ratio of ≥93:7 or ≤7:93 and (ii) 60 to 5 weight percent based on the weight of all polylactides in the composition of a non-crystallizable polylactide having a number-average molecular weight as measured by gel permeation chromatography against a polystyrene standard of at least 5000 g/mol and containing at least 90% by weight lactic units, wherein the lactic units are L-lactic units and D-lactic units in a ratio of ≥20:80 or ≤80:20;
(b) extruding the polylactide blend through an extrusion die in a machine direction to produce a polylactide sheet having a machine direction corresponding to the direction of movement of the polylactide blend through the extrusion die, and an orthogonal transverse direction, and
(c) sequentially or simultaneously stretching the sheet in orthogonal directions at a temperature of 50° C. to 120° C. to produce the biaxially oriented polylactide film.

In yet another aspect, the invention is a process for producing a biaxially oriented polylactide film, comprising (a) forming a polylactide resin composition by melt- or solution-blending, the polylactide resin composition comprising:
(i) 40 to 95 weight percent based on the weight of all polylactides in the composition, of a crystallizable polylactide having a number-average molecular weight as measured by gel permeation chromatography against a polystyrene standard of at least 5000 g/mol and containing at least 90% by weight lactic units, wherein the lactic units are L-lactic units and D-lactic units in a ratio of ≥93.7 or ≤7:93 and (ii) 60 to 5 weight percent based on the weight of all polylactides in the composition of a non-crystallizable polylactide having a number-average molecular weight as measured by gel permeation chromatography against a polystyrene standard of at least 5000 g/mol and containing at least 90% by weight lactic units, wherein the lactic units are L-lactic units and D-lactic units in a ratio of ≥20:80 or ≤80:20;
(b) extruding the polylactide resin composition to form a tube;
(iii) quenching and collapsing the tube;
(iv) heating the collapsed tube to a temperature of 50° C. to 120° C. and re-inflating the tube to stretch the tube in a transverse direction while drawing the tube in a machine direction to stretch the tube in the machine direction to produce the biaxially oriented polylactide film.

The crystallizable polylactide has a number-average molecular weight as measured by GPC (gel permeation chromatography) against polystyrene standards of at least 5000 g/mol. The number-average molecular weight may be, for example, up to 200,000 g/mol. Number-average molecular weights of about 30,000 to 130,000 g/mol are generally preferred. The crystallizable polylactide is in some embodiments characterized by having a relative viscosity of 1.1 to 6, such as 1.25 to 5, or 1.5 to 4.5, measured using a 1% wt/vol solution of the polylactide resin in chloroform against a chloroform standard on a capillary viscometer at 30° C.

Lactic units constitute at least 90% or at least 95% by weight of the crystallizable polylactide. The crystallizable polylactide may further contain repeating units formed from other monomers that are copolymerizable with lactide, such as alkylene oxides (including ethylene oxide, propylene oxide, butylene oxide, tetramethylene oxide, and the like), cyclic lactones, or carbonates. Repeating units derived from these other monomers can be present in block and/or random arrangements. These other repeating units suitably constitute up to 10% by weight of the crystallizable polylactide, preferably 0% to 5% by weight, especially about 0% to 2% by weight thereof, and may be absent.

The crystallizable polylactide (i) may also contain residues of an initiator compound, which is often used during the polymerization process to provide molecular weight control. Suitable such initiators include, for example, water, alcohols, polyhydroxy compounds of various types (such as ethylene glycol, propylene glycol, polyethylene glycol, polypropylene glycol, other glycol ethers, glycerin, trimethylolpropane, pentaerythritol, polymeric initiators having hydroxyl and/or carboxyl groups such as polylactic acid oligomers, hydroxyl-terminated butadiene polymers, polyether polyols and polyester, and the like), polycarboxyl-containing compounds, and compounds having at least one carboxyl and one hydroxyl group (such as lactic acid or lactic acid oligomer). The initiator residue preferably constitutes no more than 10%, and especially no more than 5% or no more than 2% of the weight of the crystallizable polylactide except in the case in which the initiator is a residue of a lactic acid or lactic acid oligomer, which can constitute any proportion of the crystallizable polylactide.

The lactic units in the crystallizable polylactide (i) consist of L-lactic units and D-lactic units in a ratio of ≥93:7 or ≤7:93. This ratio may be, for example, 93:7 to 100:0, 95:5 to 100:0, 7:93 to 0:100 or 5:95 to 0:100. It is preferred that the L-lactic units and D-lactic units are arranged randomly.

The crystallizable polylactide (i) is in some embodiments a homopolymer of L-lactide or a random copolymer of L-lactide with one or more of meso-lactide and D-lactide, and rac-lactide. If such a copolymer, the proportion of the various lactides is selected to provide a ratio of L-lactic units to D-lactic units of 93:7 to 99.9:0.1 or 95:5 to 99.9:0.1.

The crystallizable polylactide (i) is in alternative embodiments a homopolymer of D-lactide or a random copolymer of D-lactide with one or more of meso-lactide, L-lactide, and rac-lactide. In such a case, the proportion of the various lactides is selected to provide a ratio of L-lactic units to D-lactic units of 7:93 to 0.1:99.9 or 5:95 to 0.1:99.9.

The crystallizable polylactide (i) can be crystallized to form a semi-crystalline polymer. By “crystallizable,” it is meant the polylactide, after being heated by itself at 110° C. in air for one hour, contains at least 5 J/g, preferably at least 15 J/g or more preferably at least 20 J/g of crystallites. A polylactide that develops less than 5 J/g of crystallinity under these conditions is “non-crystallizable” for purposes of this invention. The sample is previously heated to at least 220° C. to melt any crystallites and then quenched by rapidly cooling to room temperature (23±3° C.). The quenched sample is then heated at 110° C. for one hour and again quenched by cooling to room temperature. Crystallinity is then conveniently measured using differential scanning calorimetry (DSC) methods. The amount of such crystallinity is expressed herein in terms of J/g, i.e., the enthalpy of melting, in Joules, of the polylactide crystals in the sample, divided by the weight in grams of polylactide(s) in the sample. A convenient test protocol for making DSC measurements is to heat a 5-10 milligram sample from 25° C. to 225° C. at 20° C./minute under air, on a Mettler Toledo DSC 3+ calorimeter running STARe V.16 software, or equivalent apparatus.

In some embodiments the crystallizable polylactide has a glass transition temperature of 55° C. to 65° C. and, when crystallized, a crystalline melting temperature of 95° C. to 195° C., especially 120° C. to 185° C.

The crystallizable polylactide (i) may have long-chain branches (having 3 or more carbon atoms). Long-chain branches can be introduced in the polylactide in various ways, such as by reacting carboxyl groups on the polylactide with epoxide groups that are present on a (meth)acrylate polymer or copolymer. The (meth)acrylate polymer or copolymer is characterized as being a solid at 23° C., containing an average of from about 2 to about 15 free epoxide groups/molecule (such as from about 3 to about 10 or from about 4 to about 8 free epoxide groups/molecule), and being a polymerization product of at least one epoxy-functional acrylate or methacrylate monomer, preferably copolymerized with at least one additional monomer. The (meth)acrylate polymer or copolymer suitably has a number-average molecular weight per epoxide group of about 150 to about 700, such as from 200 to 500 or from 200 to 400 g/mol. The (meth)acrylate polymer or copolymer suitably has a number-average molecular weight of from 1000 to 6000, such as from about 1500 to 5000 or from about 1800 to 3000 g/mol. Other approaches to introducing long-chain branching are described in U.S. Pat. Nos. 5,359,026 and 7,015,302, WO 06/002372A2 and WO 2019/152264.

In preferred embodiments, the crystallizable polylactide (i) lacks long-chain branches.

Two molecules of lactic acid can condense with the elimination of two molecules of water to form a 3,6-dimethyl-1,4-dioxane-2,5-dione, which is referred to herein as “lactide”. Lactide can be considered as being made up of two “lactic units”, each of which has the structure:

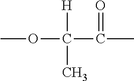

Each lactic unit in a lactide molecule contains one chiral center and exists in either the D- or the L-form. A lactide molecule can take one of three forms: 3S,6S-3,6-dimethyl-1,4-dioxane-2,5-dione (L-lactide), 3R,6R-3,6-dimethyl-1,4-dioxane-2,5-dione (D-lactide), and 3R,6S-3,6-dimethyl-1,4-dioxane-2,5-dione (meso-lactide). These have the following structures:

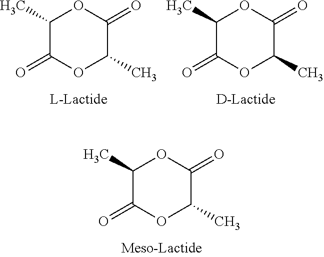

L-lactide and D-lactide are a pair of enantiomers, while meso-lactide is a stereoisomer having one L-lactic unit and one D-lactic unit. In addition, a mixture of about 50% L-lactide and 50% D-lactide forms a high-melting material known as racemic-lactide (or “rac-lactide”). Hydrolysis of meso-lactide and rac-lactide will both yield a mixture of 50% L-lactic acid and 50% D-lactic acid.

The crystallizable polylactide (i) preferably is produced by polymerizing L-lactide or D-lactide by itself or by copolymerizing L- or D-lactide and meso-lactide, preferably in random fashion, at ratios such that the ratio of L:D lactic units is ≥93:7 or ≤7:93. Polymerization can be conducted batch-wise, semi-continuously, or continuously.

A suitable polymerization temperature preferably is above the melting temperature of the monomer or monomer mixture and above the melting temperature of the crystallizable polylactide so produced, but below the temperature at which significant polymer degradation occurs. The temperature range may be, for example, as low as 60° C. or as much as 225° C.

Molecular weight and conversion are controlled by polymerization time and temperature, the equilibrium between free lactide and the polymer, and by the use of initiator compounds. In general, increasing quantities of initiator compounds on a molar basis will tend to decrease the molecular weight of the product polymer. Molecular weight control agents such as described in U.S. Pat. No. 6,277,951 can also be added to obtain the desired molecular weight.

It is preferred to perform the polymerization in the presence of a polymerization catalyst. Examples of these catalysts include various tin compounds such as SnCl₂, SnBr₂, SnCl₄, SnBr₄, SnO, tin (II) bis(2-ethyl hexanoate), butyltin tris(2-ethyl hexanoate), hydrated monobutyltin oxide, dibutyltin dilaurate, tetraphenyltin, and the like; PbO, zinc alkoxides, zinc stearate, compounds such as aluminum alkoxides, compounds such as antimony triacetate and antimony (2-ethyl hexanoate), compounds such as bismuth (2-ethyl hexanoate), calcium stearate, magnesium stearate, certain yttrium and rare earth compounds such as are described in U.S. Pat. No. 5,208,667 to McLain et al., chiral (R)-(SalBinap)-AlOCH₃ complexes as described in Macromol. Chem. Phys. 1996, 197, 2627-2637, single-site β-diimidate zinc alkoxide catalysts as described in JACS 1999, 121, 11583-11584, lithium t-butoxide aggregates as described in Macromolecules 1995, 28, 3937-3939 and Polymer 1999, 40, 5455-5458; aluminum and yttrium-based catalyst complexes as described in JACS 2002, 124, 1316-1326, dinuclear indium catalysts as described in Macromolecules 2016, 49, 909-919, and the like. Catalysts are used in catalytically effective amounts, which depend somewhat on the particular catalyst, but are usually in the range of 1 mole of catalyst per 3000 to 50,000 moles of monomers.

The resulting crystallizable polylactide contains metal catalyst residues, which are preferably deactivated by contacting the crystallizable polylactide with a deactivating agent.

The residence time under polymerization conditions is selected to produce a polymer of the desired molecular weight and/or desired conversion of monomers.

Other ways of making the crystallizable polylactide include condensation polymerization of lactic acid, and solid-state polymerization methods starting from an oligomeric polylactic acid.

The crystallizable polylactide may contain residual lactide. If present, lactide may constitute up to 1%, up to 0.5%, up to 0.3% or up to 0.2% of the weight of polylactide (i).

The non-crystallizable polylactide (ii) has a number-average molecular weight as measured by gel permeation chromatography against a polystyrene standard of at least 5000 g/mol and at least 90% by weight lactic units, and wherein the lactic units are L-lactic units and D-lactic units in a ratio of ≥20:80 or ≤80:20. In some embodiments, the lactic units are L-lactic units and D-lactic units in a ratio of 20:80 to 40:60 or 80:20 to 60:40. The non-crystallizable polylactide can be prepared in the same general manner described with regard to the crystallizable polylactide, except the lactides are selected to produce the aforementioned ratios of L-lactic units to D-lactic units. The non-crystallizable polylactide may be, for example, (a) a copolymer of L-lactide with one or more of D-lactide or meso-lactide; (b) a copolymer of D-lactide with one or more of L-lactide or meso-lactide; (c) a polymer of rac-lactide; (d) a copolymer of rac-lactide with meso-lactide, or (e) a homopolymer of meso-lactide.

In preferred embodiments, the non-crystallizable polylactide (ii) is a poly(meso-lactide). For purposes of this invention, a poly(meso-lactide) (PMLA) is a homopolymer of meso-lactide or a copolymer of at least 80% meso-lactide and up to 20% of another lactide, preferably at least 88% meso-lactide and up to 12% of another lactide or at least 90% meso-lactide and up to 10% of another lactide. If a copolymer, then the copolymer may be a random and/or block copolymer. The other lactide may be any other lactide, including L-lactide, D-lactide, or a mixture of any two or more thereof.

Meso-lactide is unique among these various forms of lactide because, as it homopolymerizes, the number of consecutive L-lactic units and D-lactic units produced in the polymer is at a minimum 1 or a maximum 2. Polymerization of mixtures of L-lactide and D-lactide will incorporate segments of even-numbered lactic acid units in the polymer, the average block length of which will be determined by the ratio of monomers present in the feedstock. A molecule of meso-lactide, when adding onto the end of a growing polymer chain during the polymerization process, introduces a single L-lactic unit and a single D-lactic unit to the chain end. If the meso-lactide polymerizes in a “head-to-tail” manner (i.e., a D-lactic unit adds to a terminal L-lactic unit on the polymer chain or vice versa), a stereoregular polymer having the form:

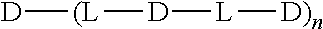

is produced, where D designates a D-lactic unit and L denotes an L-lactic unit. A PMLA having this configuration is sometimes referred to as “syndiotactic”. In this configuration, the number of consecutive D- and L-lactic units is always 1. Conversely, if the meso-lactide polymerizes in “head-to-head” manner (i.e., if a D-lactic unit adds to a terminal D-lactic unit), a polymer having the form:

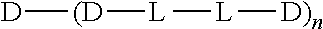

is instead produced. A PMLA having this structure is sometimes referred to as “heterotactic” or “di-syndiotactic”. In this case, the number of consecutive D- and L-lactic units is always 2. When the meso-lactide polymerizes randomly, the number of consecutive D- and L-lactic units is sometimes 1 and sometimes 2, with an average between 1 and 2.

The PMLA may be heterotactic, or partially syndiotactic and partially heterotactic. The selection of catalyst and polymerization temperature each can affect the stereochemistry of the PMLA. In general, the selection of a higher polymerization temperature, particularly 120° C. or greater and especially 150° C. or higher, has been found to lead to less stereospecificity in the PMLA, leading to an average block length of greater than 1 and less than 2. Similarly, tin-based catalysts also tend to favor lower stereospecificity. In some embodiments, the PMLA is polymerized with a tin catalyst at a temperature of at least 120° C., preferably at least 150° C., and up to 225° C., more preferably up to 190° C.

The average length of blocks of L-lactic units and of D-lactic units in the PMLA may be, for example, equal to at least 1.1, at least 1.2, at least 1.25, or at least 1.3 and, for example, up to 2, up to 1.75, up to 1.5, or up to 1.4. The average block length can be determined by proton NMR using methods to determine Pₘ as described by Coates et al., in J. American Chemical Society 2002, 124, 1316, and the following relationship:

$$Average block length = 1 + ( {P}_{m} / ( 1 + ( 1 {P}_{m} ) ) )$$

At least 90% or at least 95% of the weight of the non-crystallizable polylactide (ii) is made up of lactic units.

The number-average molecular weight of the non-crystallizable polylactide (ii) may be, for example, in the range of 5000 to 250,000 g/mol, as measured by GPC against a polystyrene standard. Number-average molecular weights of about 30,000 to 130,000 g/mol are preferred.

The non-crystallizable polylactide (ii) is in some embodiments characterized by having a relative viscosity of 1.1 to 6, 1.25 to 5, or 1.5 to 3.5, measured using a 1% wt/vol solution of the polylactide resin in chloroform against a chloroform standard on a capillary viscometer at 30° C.

In some embodiments, the non-crystallizable polylactide has a glass transition temperature of 38° C. to 50° C.

The other characteristics of the non-crystallizable polylactide (ii), and the manner in which it is manufactured, are as described above with regard to the crystallizable polylactide (i).

The polylactide resin composition comprises a mixture of the crystallizable polylactide (i) and the non-crystallizable polylactide (ii). The polylactide resins are melt- or solution-blended, rather than being a physical mixture of separate particles of the constituent polylactides. The crystallizable polylactide (i) may constitute 40 to 95 weight percent of the total weight of all polylactides in the polylactide resin composition. In particular embodiments, the crystallizable polylactide constitutes at least 50%, at least 60%, or at least 65% of the total weight of all polylactides in the polylactide resin composition, and up to 90%, up to 85% or up to 80% thereof.

When used in a process for making oriented film in accordance with the invention, the non-crystallizable polylactide (ii) may constitute 5 to 60 weight percent of the total weight of all polylactides in the polylactide resin composition. In some embodiments, the non-crystallizable polylactide (ii) may constitute at least 10%, at least 15%, at least 20%, at least 25% and up to 45%, up to 40%, or up to 35% of all polylactides in the polylactide resin composition.

Other polylactides, different from the crystallizable polylactide (i) and the non-crystallizable polylactide (ii), may be present, but if present preferably constitute no more than 10%, no more than 5%, or no more than 2% of the total weight of the constituent polylactides and may be absent.

The polylactide resin composition may contain other materials as may be useful for the particular end-use application in which it will be used. These may include, for example, polymers other than polylactides, i.e., a non-polylactide polymer.

A non-polylactide polymer, if present at all, may constitute, for example 0.1 to 50%, 1 to 25% or 1 to 10%, of the combined weight of the non-polylactide polymer and the polylactides.

Other optional materials that may be present in the polylactide resin composition include crystallization nucleators such as finely divided solids; colorants; impact modifiers; internal and/or external lubricants, anti-block, and other extrusion processing aids; additives for controlling PLA hydrolysis and/or biodegradation properties, and the like.

The polylactide resin composition can be formed by forming a solution of both polylactide (i) and polylactide (ii) in a suitable solvent, and then removing the solvent. Separate solutions of polylactides (i) and (ii) can be formed and combined, if desired, to form the polylactide resin composition. Alternately, polylactides (i) and (ii) can be dissolved together into a single solvent to form a solution from which the solvent is subsequently removed.

A preferred way of making the polylactide resin composition is by melt-blending. The crystallizable and non-crystallizable polylactides are conveniently heated to a temperature above the crystalline melting temperature of the crystallizable polylactide and mixed at such a temperature, preferably under shear, to form a blend. The polylactides may be heated separately but it is generally preferred to form a mixture of particles (pellets, powders) of the polylactides and melt them together. A preferred apparatus is a single-screw or twin-screw extruder. The particulate polylactides may be fed to the extruder individually or as a mixture, where they are melted and mixed by operation of the screw(s) to form the polylactide resin composition. In particularly preferred processes, a melt-blending step is integrated with all or part of the subsequent stretching process to form a biaxially oriented film.

The polylactide resin composition of the invention finds particular application in making oriented films. In one method of making such film, the polylactide resin composition is extruded to form a sheet. The sheet may have a thickness of, for example, at least 250 μm, at least 500 μm or at least 750 μm and up to 2000 μm, up to 1500 μm, up to 1250 μm or up to 1000 μm. The sheet-extrusion step is conveniently but not necessarily combined with a melt-blending step to form the polylactide resin composition, by performing the melt-blending step in an extruder and then extruding the blended polylactides thus formed through an extrusion die attached to the same extruder, to produce the sheet. It is, however, within the scope of the invention to melt-blend the crystallizable and non-crystallizable polylactides and form the sheet in different apparatus and/or at different times.

The sheet is formed by heating the polylactide resin composition above the crystalline melting temperature of the crystallizable polylactide, preferably to a temperature of 190° C. to 225° C., to form a melt which is then passed through an annular or slit die to produce a sheet. The direction of movement of the polylactide resin composition through the die is referred to as the “machine” direction of both the process and the resulting sheet. The sheet is subsequently cooled to below the glass transition temperature of the crystallizable polylactide. Unless the sheet is to be stretched immediately, it is generally preferred to “quench” the sheet by cooling it rapidly to below the glass transition temperature of the crystallizable polylactide to minimize crystallization.

The sheet is then stretched in at least one direction to produce oriented film. If only uniaxially oriented, stretching is performed in only one direction, typically the machine direction. Biaxially oriented film is stretched in two orthogonal directions, typically, the machine direction and the transverse direction (i.e, the direction in the plane of the sheet, perpendicular to the machine direction). When biaxially oriented, stretching can be performed in both directions simultaneously or sequentially. When performed sequentially, it is usually beneficial to stretch first in the machine direction and then in the transverse direction.

Stretching can be performed, for example, by passing the sheet through two successive sets of rollers, the second set being operated at a faster rate than the first set, thereby stretching and uniaxially orienting the sheet. Stretching also can be performed using, for example, a tenter frame or other apparatus having grips that attach to opposing sides of the sheet. The grips are operated to pull the opposing sides apart, thereby stretching the sheet.

Stretching can be integrated with the sheet extrusion step by performing the stretching step(s) immediately after the sheet is extruded. The temperature of the newly extruded sheet is adjusted to temperatures as described below, and then uniaxially (preferably in the machine direction) or biaxially (typically sequentially in the machine direction first followed by stretching in the transverse direction). After the stretching steps are completed, the oriented film is cooled to below the glass transition temperature of the crystallizable polylactide. In such a process, the machine direction stretch may be performed using two successive sets of rollers as described before to produce a uniaxially oriented film. The first set of rollers in such a process may include or be preceded by a chill roll that cools the sheet to the stretch temperature as indicated below. The subsequent transverse stretch preferably is performed continuously by attaching grips to the sides of the uniaxially stretched film and operating the grips to pull the opposing sides apart in the transverse direction. A cooling step may be performed after the first stretching step, followed by heating again as necessary to the temperature at which the second stretching step is performed.

Alternatively, the sheet can be stretched simultaneously in both the machine and transverse directions by, for example, attaching clips to all four sides of the sheet and pulling the opposing sides apart, or by a combination of a tenter to stretch the sheet in a transverse direction and a roller system to stretch in the machine direction.

In other embodiments, the sheet extrusion and stretching (orientation) steps are not integrated, but instead carried out in separate manufacturing steps. In such processes, the extruded sheet is conveniently prepared as described before, and after extrusion is cooled to below the glass transition temperature of the crystallizable polylactide, preferably rapidly to avoid excessive crystallization of the crystallizable polylactide phase(s) and stretched in a subsequent operation. Apparatus as described before is useful.

Suitable commercially available equipment for biaxially stretching flat sheets is sold by, for example, Parkinson Technologies, Inc. (under the Marshall and Williams Plastics brand), Biax-Fiberfilm Corporation (Microspan® stretching equipment), Brueckner-USA, Andritz Bias SAS, Japan Steel Works, Ltd., among many others.

The stretching steps are performed at a temperature of 50° C. to 120° C. A preferred lower temperature is at least 55° C., at least 60° C. or at least 70° C. A preferred upper temperature is up to 100° C.

In a sequential stretching process in which a machine direction stretch is performed first, followed by a transverse direction stretch, the machine direction stretch preferably is performed at a temperature of 50° C. to 120° C., preferably 55 to 100° C., and the subsequent transverse direction stretch preferably is performed at a temperature of 70° C. to 120° C., most preferably 70° C. to 100° C.

Simultaneous biaxial stretching preferably is performed at a temperature of 70° C. to 120° C., most preferably 70° C. to 100° C.

The crystallizable polylactide phase of the sheet will crystallize when brought to the aforementioned stretching temperature, if given enough time. If it crystallizes too much, it becomes more difficult to stretch. It is preferred to perform all stretching steps on sheet that has been at the stretching temperature a cumulative period of no more than 2 minutes, preferably no more than 1 minute or no more than 30 seconds, to avoid over-crystallizing polylactide (i).

Stretching rates may be, for example, 10% to 500% of the pre-stretch dimension of the starting sheet (in the direction of stretching) per second, i.e., the sheet may be stretched each second by a distance equal to 10% to 500% of its original dimension in the direction of stretching. A preferred stretch rate is 25 to 200% per second or 25 to 100% per second.

In stretching a flat sheet, stretch ratios in general may be 3 to 10 in each of the machine and transverse directions. A preferred stretch ratio in the machine direction is 3 to 6 or 3 to 5, and a preferred stretch ratio in the transverse direction is 3 to 10, 4 to 10, 5 to 9 or 5.5 to 9. A somewhat lower stretch ratio is sometimes seen in the machine direction. The area of uniaxially oriented film may be 3 to 10 times that of the starting sheet, and the uniaxially oriented film thickness may be, for example, one-third to one-tenth that of the starting sheet. The area of biaxially oriented film may be, for example, 9 to 100 times that of the starting sheet, preferably 9 to 64 times, 12 to 50 times or 15 to 36 times that of the starting sheet. The thickness of biaxially oriented film may be, for example, one-ninth to one one-hundredth that of the starting sheet. Oriented film thickness in either the uniaxially oriented or biaxially oriented case may be, for example, at least 4 μm, at least 8 μm or at least 12 μm and up to 200 μm, up to 100 μm, up to 50 μm.

The stretch ratios obtainable with this process of the invention depend at least in part on the proportion of the non-crystallizable polylactide in the polylactide resin composition. Increasing the proportion of the non-crystallizable polylactide generally enables greater stretch ratios to be achieved.

Increasing the sheet temperature during the stretching process also tends to allow greater stretch ratios to be achieved.

Alternatively, biaxially stretched film can be produced in a so-called “double bubble” process. In a double bubble process, the polylactide resin composition is extruded to form a tube. The tube is quenched by cooling it to near or below the glass transition temperature of the crystallizable polylactide and collapsed. The collapsed tube is then heated to a temperature of 50° C. to 120° C., preferably 70° C. to 120° C. and re-inflated with air or other gas to stretch the tube in a transverse direction while stretching the tube in a machine direction. Double bubble biax film methods are described, for example, in WO 2001/070483,

After the stretching step is completed, the resulting biaxially oriented films may be heat annealed at a temperature of, for example, 70° C. to 150° C., preferably 120 to 140° C. or 120 to 135° C. Annealing at such temperatures may be continued, for example, for a period of 5 seconds to 5 minutes, especially 5 to 30 seconds. Annealing should be performed under tension. Annealing in such a manner reduces film shrinkage when exposed to elevated temperatures.

The following examples illustrate the invention but are not intended to limit it in any way. All parts and percentages are by weight unless otherwise indicated.

Non-crystallizable PLA A is a poly(meso-lactide). It is a linear copolymer made by polymerizing a mixture of about 90% meso-lactide and 10% L-lactide in the presence of a tin catalyst at 160-180° C. Lactic units constitute over 98% of the total weight of Non-Crystallizable PLA A. 45% of the lactic units are D-lactic units and 55% are L-lactic units. Non-crystallizable PLA A has an average length of blocks of L-lactic units and of D-lactic units between 1.1 and 1.75. It has a relative viscosity of 2.7.

Non-crystallizable PLA B is a linear copolymer made by polymerizing a mixture of L-lactide, meso-lactide and D-lactide. Lactic units constitute over 98% of the total weight of Non-Crystallizable PLA B. 80% of the lactic units are L-lactic units and 20% are D-lactic units.

Crystallizable PLA A is commercially available as Ingeo® 4032D resin from NatureWorks LLC, Plymouth, Minnesota US. Lactic units constitute over 98% of the total weight of Crystallizable PLA A. About 1.4% of the lactic units are D-lactic units and about 98.6% are L-lactic units. Crystallizable PLA A has a relative viscosity of 4.0.

Crystallizable PLA B is commercially available as Ingeo® 4043D resin from NatureWorks LLC. Lactic units constitute over 98% of the total weight of Crystallizable PLA B. 4.25% of the lactic units are D-lactic units and 95.75% are L-lactic units. Crystallizable PLA B has a relative viscosity of 4.0.

Crystallizable PLA C is commercially available as Ingeo® 2500HP resin from NatureWorks LLC. Lactic units constitute over 98% of the total weight of Crystallizable PLA C. 0.5% of the lactic units are D-lactic units and 99.5% are L-lactic units. Crystallizable PLA C has a relative viscosity of 4.0.

### EXAMPLES 1-8 AND COMPARATIVE SAMPLES A-B

Cast sheets having a thickness of 650 to 800 μm are prepared from Crystallizable PLA A, Crystallizable PLA B and mixtures of Crystallizable PLA A or Crystallizable PLA B with Non-Crystallizable PLA A, as indicated in Table 1. Pellets of the PLA materials are melted in a twin-screw extruder where they are blended and extruded before being cast into sheet and quenched.

TABLE 1

| Desig- | Crystallizable | Non-Crystallizable |
|---|---|---|
| nation | PLA Type/wt.-% | PLA A, wt.-% |
| A* | A/100% | 0 |
| 1 | A/90% | 10% |
| 2 | A/80% | 20% |
| 3 | A/60% | 40% |
| 4 | A/40% | 60% |
| B* | B/100% | 0% |
| 5 | B/90% | 10% |
| 6 | B/80% | 20% |
| 7 | B/60% | 40% |
| 8 | B/40% | 60% |

*Not an example of the invention.

A sample of Example 5 is examined by atomic force microscopy in tapping mode at 25° C. and 95% RH, using a Keysight 5500 apparatus equipped with a high-speed force-curve mapping capability. Prior to the AFM analysis, the samples are microtomed at −120° C. to produce smooth, flat regions for scanning. Crystallizable PLA B and Non-crystallizable PLA A are imaged as separate phases, as shown in FIG. 1, Crystallizable PLA B forming a continuous phase and Non-crystallizable PLA A forming discrete domains approximately 5-10 nm in size dispersed within the continuous phase.

A 50/50 by weight blend of Crystallizable PLA B and Non-Crystallizable PLA A is prepared in the manner described before and examined by atomic force microscopy in the manner just described. Crystallizable PLA B and Non-crystallizable PLA-A image as co-continuous phases with domain sizes on the order of up to a few μm, as shown in FIG. 2.

Sheets as indicated in Table 2 below are sequentially stretched, at various temperatures as indicated in Table 2, on a Brueckner Karo 5.0 biaxial stretching unit, first at a stretch ratio of 3.5 in the machine direction and then in the transverse direction until rupture. The transverse stretch ratio at rupture is as indicated in Table 2.

TABLE 2

| | | Non- | | | |
|---|---|---|---|---|---|
| | Crystallizable | crystallizable | Transverse Stretch | | |
| Desig- | PLA, | PLA, | Ratio at Break | | |
| nation | type/wt.-% | type/wt.-% | 75° C. | 80° C. | 85° C. |
| A* | A/100 | 0 | 3.0 | 2.5 | 1.9 |
| 1 | A/90 | A/10 | 2.4^{a} | 4.0 | 5.0 |
| 2 | A/80 | A/20 | 4.1 | 5.4 | 6.1 |
| 3 | A/60 | A/40 | 5.1 | 4.6 | 7.3 |
| 4 | A/40 | A/60 | 9.3 | 9.7 | 8.0 |
| B* | B/100 | 0 | 4.0 | 5.1 | 5.4 |
| 5 | B/90 | A/10 | 4.5 | 5.5 | 5.5 |
| 6 | B/80 | A/20 | 5.1^{a} | 4.9 | 5.8 |
| 7 | B/60 | A/40 | 5.9 | 6.0 | 6.2 |
| 8 | B/40 | A/60 | 8.1 | 8.0 | 8.5 |

*Not an example of the invention.
^{a}Sample has visible surface defects before stretching.

Sheets as indicated in Tables 3-11 below are then sequentially stretched, first in the machine direction and then in the transverse direction, on a Brueckner Karo 5.0 biaxial stretching unit, at various temperatures and various stretch ratios as indicated in Tables 3, 6 and 9. Preheat time is 30 seconds in each case. Stretched samples are annealed under tension at 120° C. for 30 seconds immediately after stretching. The stretched sheets are evaluated for % total haze per ASTM D1003-21 and for shrinkage per ASTM D2732-14. For certain samples, internal haze is evaluated by submersing the sample into clear corn oil in a glass cuvette then re-measuring haze per ASTM D1003-21. Haze of the blank (oil and cuvette) are subtracted from the measured sample to determine the sample's internal haze. The difference of total haze (original) and internal haze is attributed to surface haze. Mechanical properties are measured according to ASTM D882. The results of this testing are as indicated in Tables 4, 5, 7, 8, 10 and 11.

TABLE 3
Stretch Ratios, 75° C. Stretch

| | Crystallizable/ | Stretching | Stretch Ratio | | Draw |
|---|---|---|---|---|---|
| Desig- | Non-Crystallizable | Temp., | Machine | Transverse | Down |
| nation | PLA weight ratio | ° C. | Direction | Direction | Ratio¹ |
| A* | 100/0 | 75 | 3.5 | 3.0 | 10.5 |
| 1 | 90/10 | 75 | 3.5 | 2.5 | 8.75^{a} |
| 2 | 80/20 | 75 | 3.5 | 4.0 | 14.0 |
| 3 | 60/40 | 75 | 3.5 | 4.5 | 15.75 |
| 4 | 40/60 | 75 | 3.5 | 8.0 | 28.0 |
| B* | 100/0 | 75 | 3.5 | 3.5 | 12.25 |
| 5 | 90/10 | 75 | 3.5 | 4.0-4.5 | 14-15.75 |
| 6 | 80/20 | 75 | 3.5 | 4.5 | 15.75^{a} |
| 7 | 60/40 | 75 | 3.5 | 5.0-5.5 | 17.5-19.25 |
| 8 | 40/60 | 75 | 3.5 | 6.5-7.0 | 22.75-24.5 |

*Not an example of the invention.
^{a}Sample has visible surface defects before stretching.
¹Product of machine and transverse direction stretch ratios, indicating the increase in surface area relative to the unstretched sheet.

TABLE 4
75° C. Stretched Biax Film Properties

| | Crystallizable/ | Film | Total | Internal | Surface | Shrinkage, | |
|---|---|---|---|---|---|---|---|
| | Non-Crystallizable | Thickness, | Haze, | Haze, | Haze, | % | |
| Designation | PLA weight ratio | μm | % | % | % | MD | TD |
| A*¹ | 100/0 | N.D. | 4 | 0.7 | 3.3 | ND | ND |
| 2 | 80/20 | 68 | 1.6 | ND | ND | 7.5 | 9.0 |
| 3 | 60/40 | 68 | 3.1 | ND | ND | 3.0 | 5.5 |
| 4 | 40/60 | 32 | 13.1 | 0.9 | 12.2 | 3 | 11.5 |
| B* | 100/0 | 32 | 1.5 | 0.5 | 1.0 | 4.5 | 8.5 |
| 6 | 80/20 | 38 | 1.3 | ND | ND | 10 | 10 |
| 7 | 60/40 | 37 | 1.8 | ND | ND | 6 | 8 |
| 8 | 40/60 | 32 | 4.2 | 0.8 | 3.4 | 3 | 7.5 |

*Not an example of the invention.
¹Stretched sample has many flow lines.

TABLE 5
75° C. Stretched Biax Film Mechanical Properties

| | | Tensile | | Tensile | | | |
|---|---|---|---|---|---|---|---|
| | | Modulus, | | Strength at | | Elongation | |
| | Crystallizable/ | kpsi | | Break, kpsi | | at Break, | |
| | Non-Crystallizable | (MPa) | | (MPa) | | % | |
| Designation | PLA weight ratio | MD | TD | MD | TD | MD | TD |
| 2 | 80/20 | 384 | 448 | 15.5 | 22.3 | 96 | 71 |
| | | (2650) | (3088) | (107) | (154) | | |
| 3 | 60/40 | 387 | 371 | 15.3 | 12.6 | 93 | 54 |
| | | (2666) | (2555) | (106) | (87) | | |
| 4 | 40/60 | 305 | 325 | 11.3 | 9.4 | 104 | 19 |
| | | (2103) | (2241) | (78) | (65) | | |
| B* | 100/0 | 366 | 442 | 15.8 | 20.9 | 95 | 90 |
| | | (2524) | (3044) | (109) | (143) | | |
| 5 | 90/10 | 314 | 411 | 14.7 | 21.9 | 110 | 75 |
| | | 2160) | (2843) | (101) | (151) | | |
| 6 | 80/20 | 369 | 413 | 13.8 | 23.2 | 95 | 82 |
| | | (2546) | (2843) | (95) | (160) | | |
| 7 | 60/40 | 350 | 385 | 12.8 | 18.2 | 106 | 77 |
| | | (2412) | (2654) | (88) | (125) | | |
| 8 | 40/60 | 333 | 315 | 10.3 | 10.1 | 100 | 74 |
| | | (2296) | (2171) | (71) | (70) | | |

*Not an example of the invention.

TABLE 6
Stretch Ratios, 80° C. Stretch

| | Crystallizable/ | Stretching | Stretch Ratio | | Draw |
|---|---|---|---|---|---|
| Desig- | Non-Crystallizable | Temperature, | Machine | Transverse | Down |
| nation | PLA weight ratio | ° C. | Direction | Direction | Ratio¹ |
| A* | 100/0 | 80 | 3.5 | 2.0 | 7.0 |
| 1 | 90/10 | 80 | 3.5 | 3.5 | 12.25^{a} |
| 2 | 80/20 | 80 | 3.5 | 5.0 | 17.5 |
| 3 | 60/40 | 80 | 3.5 | 4.5 | 15.75 |
| 4 | 40/60 | 80 | 3.5 | 7.5 | 33.75 |
| B* | 100/0 | 80 | 3.5 | 4.5 | 15.75 |
| 5 | 90/10 | 80 | 3.5 | 4.5-5.0 | 15.75-17.5 |
| 6 | 80/20 | 80 | 3.5 | 4.0 | 14.0^{a} |
| 7 | 60/40 | 80 | 3.5 | 5.5-6.0 | 19.25-21 |
| 8 | 40/60 | 80 | 3.5 | 7.0 | 24.5 |

*Not an example of the invention.
^{a}Sample has visible surface defects before stretching.
¹Product of machine and transverse direction stretch ratios, indicating the increase in surface area relative to the unstretched sheet.

TABLE 7
80° C. Stretched Biax Film Properties

| | Crystallizable/ | Film | Total | Internal | Surface | Shrinkage, | |
|---|---|---|---|---|---|---|---|
| | Non-Crystallizable | Thickness, | Haze, | Haze, | Haze, | % | |
| Designation | PLA weight ratio | μm | % | % | % | MD | TD |
| 1 | 90/10 | 53 | 0.9 | ND | ND | 4.5 | 9 |
| 2 | 80/20 | 58 | 1.2 | ND | ND | 6.0 | 11.5 |
| 3 | 60/40 | 43 | 4.1 | ND | ND | 3.0 | 12.5 |
| 4 | 40/60 | 32 | 13.6 | 1.3 | 12.3 | 2 | 5.5 |
| B* | 100/0 | 32 | 1.5 | 0.5 | 1.0 | 5.5 | 12.0 |
| 6 | 80/20 | 38 | 1.5 | ND | ND | 5 | 8 |
| 7 | 60/40 | 38 | 1.9 | ND | ND | 6 | 10 |
| 8 | 40/60 | 32 | 4.1 | 1.0 | 3.1 | 3 | 7.5 |

*Not an example of the invention.

TABLE 8
80° C. Stretched Biax Film Mechanical Properties

| | | Tensile | | Tensile | | | |
|---|---|---|---|---|---|---|---|
| | | Modulus, | | Strength at | | Elongation | |
| | Crystallizable/ | kpsi | | Break, kpsi | | at Break, | |
| | Non-Crystallizable | (MPa) | | (MPa) | | % | |
| Designation | PLA weight ratio | MD | TD | MD | TD | MD | TD |
| 1 | 90/10 | 397 | 466 | 13.8 | 27.3 | 84 | 52 |
| | | (2734) | (3209) | (95) | (188) | | |
| 2 | 80/20 | 384 | 433 | 15.0 | 24.2 | 88 | 56 |
| | | (2651) | (2984) | (104) | (167) | | |
| 3 | 60/40 | 413 | 394 | 16.0 | 12.4 | 101 | 41 |
| | | (2848) | (2717) | (110) | (85) | | |
| 4 | 40/60 | 316 | 339 | 9.4 | 9.9 | 64 | 9 |
| | | (2177) | (2333) | (65) | (68) | | |
| B* | 100/0 | 308 | 471 | 15.0 | 25.4 | 104 | 62 |
| | | (2121) | (3426) | (104) | (175) | | |
| 5 | 90/10 | 351 | 468 | 14.7 | 21.2 | 98 | 85 |
| | | (2422) | (3224) | (101) | (146) | | |
| 6 | 80/20 | 395 | 397 | 15.3 | 21.3 | 90 | 80 |
| | | (2722) | (2738) | (106) | (147) | | |
| 7 | 60/40 | 362 | 390 | 11.6 | 18.0 | 101 | 65 |
| | | (2497) | (2686) | (80) | (124) | | |
| 8 | 40/60 | 301 | 330 | 8.0 | 9.4 | 28 | 47 |
| | | (2077) | (2272) | (55) | (65) | | |

*Not an example of the invention.

TABLE 9
Stretch Ratios, 85° C. Stretch

| | Crystallizable/ | Stretching | Stretch Ratio | | Draw |
|---|---|---|---|---|---|
| Desig- | Non-Crystallizable | Temp., | Machine | Transverse | Down |
| nation | PLA weight ratio | ° C. | Direction | Direction | Ratio¹ |
| A* | 100/0 | 85 | 3.5 | 2.0 | 7.0 |
| 1 | 90/10 | 85 | 3.5 | 4.5 | 15.75^{a} |
| 2 | 80/20 | 85 | 3.5 | 5.5 | 19.25 |
| 3 | 60/40 | 85 | 3.5 | 7.5 | 26.25 |
| 4 | 40/60 | 85 | 3.5 | 8.0 | 28.0 |
| B* | 100/0 | 85 | 3.5 | 5.0 | 17.5 |
| 5 | 90/10 | 85 | 3.5 | 5.0 | 17.5 |
| 6 | 80/20 | 85 | 3.5 | 5.5 | 19.25^{a} |
| 7 | 60/40 | 85 | 3.5 | 6.0 | 21.0 |
| 8 | 40/60 | 85 | 3.5 | 7.0 | 28.0 |

*Not an example of the invention.
^{a}Sample has visible surface defects before stretching.
¹Product of machine and transverse direction stretch ratios, indicating the increase in surface area relative to the unstretched sheet.

TABLE 10
85° C. Stretched Biax Film Properties

| | Crystallizable/ | Film | Total | Internal | Surface | Shrinkage, | |
|---|---|---|---|---|---|---|---|
| | Non-Crystallizable | Thickness, | Haze, | Haze, | Haze, | % | |
| Designation | PLA weight ratio | μm | % | % | % | MD | TD |
| 1 | 90/10 | 28 | 4 | 0.7 | 3.3 | 2.5 | 9 |
| 2 | 80/20 | 38 | 1.6 | ND | ND | 6.0 | 12.5 |
| 3 | 60/40 | 46 | 3.1 | ND | ND | 3.5 | 8.5 |
| 4 | 40/60 | 38 | 13.1 | 0.9 | 12.2 | 2 | 10.5 |
| B* | 100/0 | 32 | 2.0 | 0.5 | 1.5 | 2.5 | 7.5 |
| 5 | 90/10 | 38 | 1.0 | ND | ND | 3.5 | 10.5 |
| 6 | 80/20 | 38 | 1.2 | ND | ND | 3.5 | 8 |
| 7 | 60/40 | 37 | 2.0 | ND | ND | 4 | 8 |
| 8 | 40/60 | 32 | 3.8 | 0.7 | 3.1 | 2 | 3.5 |

*Not an example of the invention.

TABLE 11
85° C. Stretched Biax Film Mechanical Properties

| | | Tensile | | Tensile | | | |
|---|---|---|---|---|---|---|---|
| | | Modulus, | | Strength at | | Elongation | |
| | Crystallizable/ | kpsi | | Break, kpsi | | at Break, | |
| | Non-Crystallizable | (MPa) | | (MPa) | | % | |
| Designation | PLA weight ratio | MD | TD | MD | TD | MD | TD |
| 1 | 90/10 | 557 | 540 | 13.3 | 25.5 | 84 | 52 |
| | | (3841) | (3721) | (92) | (176) | | |
| 2 | 80/20 | 303 | 491 | 10.3 | 29.4 | 88 | 56 |
| | | (2087) | (3383) | (71) | (203) | | |
| 3 | 60/40 | 366 | 356 | 11.2 | 16.8 | 101 | 41 |
| | | (2524) | (2453) | (77) | (116) | | |
| 4 | 40/60 | 316 | 339 | 9.4 | 9.9 | 64 | 9 |
| | | (2177) | (2333) | (65) | (68) | | |
| B* | 100/0 | 362 | 424 | 11.1 | 21.8 | 104 | 62 |
| | | (2498) | (2922) | (76) | (150) | | |
| 5 | 90/10 | 417 | 435 | 14.0 | 21.7 | 98 | 85 |
| | | (2871) | (2999) | (95) | (156) | | |
| 6 | 80/20 | 246 | 423 | 8.9 | 24.0 | 90 | 80 |
| | | (1695) | (2916) | (61) | (166) | | |
| 7 | 60/40 | 301 | 376 | 9.3 | 15.9 | 101 | 65 |
| | | (2075) | (2588) | (64) | (109) | | |
| 8 | 40/60 | 273 | 304 | 7.1 | 6.8 | 28 | 47 |
| | | (1880) | (2092) | (49) | (47) | | |

*Not an example of the invention.

As shown by the data in the foregoing tables, sheets containing 10-60% of the non-crystallizable polylactide can be stretched significantly more in the transverse direction (the machine direction stretch being held constant in these examples), than can sheets of the crystallizable polylactide by itself, producing significantly higher draw down ratios. Exceptions are seen with the 90/10 blend of Crystallizable PLA A and the Non-crystallizable PLA, and the 80/20 blend of Crystallizable PLA B and the Non-crystallizable PLA, which are attributed to imperfections in the sheet prior to stretching. Increasing the proportion of the Non-crystallizable PLA generally allows more transverse stretching before break.

Mechanical properties and appearance are generally suitable for most of the examples of the invention. However, 40/60 blends of the Crystallizable PLA with the Non-crystallizable PLA tend to exhibit a significant increase in haze (especially surface haze) and a large loss of elongation to break. These effects are more prominent when the Crystallizable PLA is very pure from an enantiomeric standpoint (i.e., Crystallizable PLA A vs. Crystallizable PLA B) and thus crystallizes more rapidly under the stretching conditions. Although the invention is not limited to any theory, the increase in haze and decrease in elongation seen in the 40/60 samples may be attributable to a change in the microphase structure of the polylactide resin composition due to the increased proportion of the Non-crystallizable PLA.

Polylactide resin composition Examples 1-8 are simultaneously stretched, at various temperatures as indicated in Table 12, on a Brueckner Karo 5.0 biaxial stretching unit. Stretch ratios are as indicated in Table 12. The stretch ratios are the highest that could be obtained under these stretching conditions without tearing the film.

TABLE 12
Simultaneous Biax Stretch Ratios

| | 75° C. Stretch | | 80° C. Stretch | | 85° Stretch | |
|---|---|---|---|---|---|---|
| Example | Ratios | | Ratios | | Ratios | |
| No. | MD | TD | MD | TD | MD | TD |
| 1 | 3.5 | 3.5 | 4 | 4 | 4.5 | 4.5 |
| 2 | 3.5 | 3.5 | 4 | 4 | 5 | 5 |
| 3 | 3.5 | 3.5 | 4.5 | 4.5 | 5 | 5 |
| 4 | 3.5 | 3.5 | 4.5 | 4.5 | 5 | 5 |
| 5 | 4 | 4 | 5 | 5 | 5 | 5 |
| 6 | 4 | 4 | 5 | 5 | 5 | 5 |
| 7 | 4.5 | 4.5 | ND | ND | 5 | 5 |
| 8 | 4.5 | 4.5 | 5 | 5 | 5.5 | 5.5 |

Additional biaxially stretched films are made using Example 2, in the same sequential stretching process as described before. Stretching temperatures and ratios are as indicated in Table 13.

TABLE 13
Biaxially stretched films using Example 2

| Property | Value | | | | |
|---|---|---|---|---|---|
| Temperature, ° C. | 85 | 90 | 95 | 95 | 95 |
| Stretch Ratio, MD | 3.5 | 3.5 | 3.5 | 3.5 | 3.6 |
| Stretch Ratio, TD | 6.5 | 6.5 | 6.5 | 8 | 10 |
| Draw Down Ratio¹ | 22.75 | 22.75 | 22.75 | 28 | 35 |
| Crystallinity, % | 32 | 32 | 35 | 36 | 35 |
| Normalized | 40 | 43 | 43 | 45 | 44 |
| Crystallinity^{c}, % | | | | | |
| MD Shrinkage, % | 5.0 | 3.25 | 1.9 | 2.1 | 1.9 |
| TD Shrinkage, % | 6.0 | 5.9 | 6.75 | 6.0 | 4.5 |
| Total Haze, % | 1.5 | 1.9 | 4.4 | 3.7 | 3.2 |
| MD Tensile Modulus, | 283 | 204 | 185 | 165 | 132 |
| kpsi (MPa) | | | | | |
| TD Tensile Modulus, | 448 | 576 | 424 | 491 | 602 |
| kpsi (MPa) | | | | | |
| MD Tensile Strength | 8.2 | 5.8 | 5.4 | 3.8 | 4.6 |
| at Break, kpsi (MPa) | | | | | |
| TD Tensile Strength | 19.1 | 28.3 | 17.8 | 20.9 | 33.1 |
| at Break, kpsi (MPa) | | | | | |
| MD Elongation at | 70 | 5.8 | 16.3 | 11.9 | 16.1 |
| Break, % | | | | | |
| TD Elongation at | 36.4 | 31.8 | 34.8 | 28.4 | 29 |
| Break, % | | | | | |

¹Product of machine and transverse direction stretch ratios, indicating the increase in surface area relative to the unstretched sheet.

### EXAMPLES 9-10 AND COMPARATIVE SAMPLE C

Cast sheets having a thickness of 650 to 800 μm are prepared from Crystallizable PLA C, and mixtures of Crystallizable PLA C with Non-Crystallizable PLA A, as indicated in Table 14. Pellets of the PLA materials are melted in a twin-screw extruder where they are blended and extruded before being cast into sheet and quenched.

TABLE 14

| | Wt.-% | Wt.-% Non- |
|---|---|---|
| Desig- | Crystallizable | Crystallizable |
| nation | PLA C | PLA A |
| C* | 100% | 0 |
| 9 | 80% | 20% |
| 10 | 60% | 40% |

*Not an example of the invention.

The sheets are then sequentially stretched in the manner described in previous examples at 85° C. to produce biaxially oriented films. When the machine direction stretch ratio is greater than 2.0, Comparative Sample C cannot be stretched to a stretch ratio of greater than 2.0 in the transverse direction. Comparative Sample C therefore is stretched only to a stretch ratio of 2.0 in the machine direction before attempting transverse stretching. Examples 9 and 10 are stretched to a stretch ratio of 3.5 in the machine direction before performing transverse stretching at a stretch ratio of 6.0 (Ex. 9) and 7.0 (Ex. 10). Film properties are measured as before, with results as indicated in Table 15. Crystallinity is measured by differential scanning calorimetry.

TABLE 15
85° C. Stretched Biax Film Properties

| | Value | | |
|---|---|---|---|
| Property | Comp. C* | Ex. 9 | Ex. 10 |
| Stretch Ratio, MD | 2^{a} | 3.5 | 3.5 |
| Stretch Ratio, TD | 6.0 | 6.0 | 7.0 |
| Draw Down Ratio | 12 | 21 | 24.5 |
| Crystallinity, % | 48 | 45 | 28 |
| Normalized | 48 | 56 | 47 |
| Crystallinity^{b}, % | | | |
| MD Shrinkage, % | 1.2 | 2.7 | 3.3 |
| TD Shrinkage, % | 3.6 | 5.1 | 5.8 |
| Total Haze, % | 1.2 | 1.6 | 6.0 |
| Internal Haze, % | ND | ND | 0.6 |
| MD Tensile Modulus, | 292 (2013) | 383 (2640) | 323 (2227) |
| kpsi (MPa) | | | |
| TD Tensile Modulus, | 491 (3385) | 635 (4378) | 328 (2261) |
| kpsi (MPa) | | | |
| MD Tensile Strength | 8.6 (59) | 11.8 (81) | 9.5 (66) |
| at Break, kpsi (MPa) | | | |
| TD Tensile Strength | 24.7 (170) | 28.4 (196) | 12.5 (86) |
| at Break, kpsi (MPa) | | | |
| MD Elongation at Break, % | 6.6 | 37.3 | 53.3 |
| TD Elongation at Break, % | 60.4 | 29.7 | 28.5 |

*Not an example of the invention.
^{a}Samples stretched greater than 2X in the machine direction could not be stretched more than 2X in the transverse direction.
^{b}Crystallinity divided by the proportion of Crystallizable PLA C in the sample.

Examples 9 and 10 illustrate the beneficial effect of the invention, even in a case in which the crystallizable PLA resin is very enantiomerically pure and crystallizes very rapidly when subjected to temperatures above its glass transition temperature (about 65° C.). Crystallizable PLA C by itself can be stretched only with difficulty and only to a low stretch ratio in the machine direction. Adding 20 to 40% of Non-Crystallizable PLA A allows the sheet to be stretched to a high draw down ratio and produce films having excellent properties.

### EXAMPLES 11-13 AND COMPARATIVE SAMPLE D

Biaxially stretched films are made on a continuous pilot coextrusion line with in-line sequential stretching elements. The pilot line includes three single-screw extruders, having operating rates of 4.54, 50 and 4.54 kg/hr, respectively. These extruders feed a 12″ (30.5 cm) wide extrusion die. The line is designed to produce transverse stretch ratios of 4 to 10. Stretching in the machine direction is performed by passing the extruded film over a slow draw roll maintained at 57-58° C. followed by a fast draw roll maintained at 54-56° C. and then an annealing roll maintained at 43-45° C. Stretch ratios in the machine direction are indicated in Table 16. The film is then forwarded to a transverse stretching zone that includes preheating to 65-66° C., stretching at 79-80° C. and annealing at 121° C. for about 30 seconds. Transverse stretch ratios are as indicated in Table 16. The machine direction stretch ratio of Comparative Sample D is limited to 2.8 to enable the film to be stretched in the transverse direction within the operational limits of the equipment (i.e., at least 4× TD stretch ratio) without breaking. Final film thickness is as indicated in Table 16. Shrinkage and crystallinity are measured as before with results as indicated in Table 16.

The resins used in Examples 11-13 and Comparative Sample D are as follows:

| Desig- | | |
|---|---|---|
| nation | Extruders 1 and 3 | Extruder 2 |
| D* | Crystallizable PLA A | Crystallizable PLA A |
| 11 | Melt-blended 70/30 mixture | 70/30 mixture of pellets |
| | of Crystallizable PLA A and | of Crystallizable PLA A and |
| | Non-Crystallizable PLA A. | pellets of Non-Crystallizable |
| | | PLA A. |
| 12 | Melt-blended 70/30 mixture | Melt-blended 70/30 mixture |
| | of Crystallizable PLA A and | of Crystallizable PLA A and |
| | Non-Crystallizable PLA A. | Non-Crystallizable PLA A. |
| 13 | Melt-blended 70/30 mixture | 80/20 mixture of pellets |
| | of Crystallizable PLA A and | of Crystallizable PLA A and |
| | Non-Crystallizable PLA A. | pellets of Non-Crystallizable |
| | | PLA A. |

TABLE 16

| | Value | | | |
|---|---|---|---|---|
| Property | Comp. D* | Ex. 11 | Ex. 12 | Ex. 13 |
| % Non-Crystallizable PLA | 0 | 30 | 30 | 20 |
| Stretch Ratio, MD | 2.8 | 3.5 | 3.5 | 3.5 |
| Stretch Ratio, TD | 5.75 | 10.0 | 10.0 | 10.0 |
| Draw Down Ratio¹ | 15.8 | 35.0 | 35.0 | 35.0 |
| Final Film Thickness, μm | 25.4 | 15.2 | 17.8 | 17.8 |
| Crystallinity, % | 32.7 | 26.7 | 26.9 | 29.7 |
| Normalized Crystallinity^{c}, % | 32.7 | 38.2 | 38.4 | 37.2 |
| MD Shrinkage, % | 4.0 | 11.0 | 9.5 | 9.0 |
| TD Shrinkage, % | 2.0 | 8.0 | 5.5 | 7.0 |

*Not an example of the invention.
^{c}Crystallinity divided by the proportion of Crystallizable PLA C in the sample.
¹Product of machine and transverse direction stretch ratios, indicating the increase in surface area relative to the unstretched sheet.

Draw down ratios for each of Examples 11-13 are more than double that of Comp. D, which at a draw down ratio of 15.8 is as great as can be obtained under these conditions using Crystallizable PLA A by itself. Examples 11 and 13 are notable in that the main blend component processed through Extruder 2 is fed as a pellet mixture; this establishes that prior melt blending is not necessary, as it can be performed in-line on continuous extrusion/stretching equipment, and further that a single screw extruder provides sufficient mixing.

### EXAMPLES 14-17

Biaxially stretched films are made in the sequential stretching process described in Example 1-8, except annealing conditions are varied as indicated Table 17. The stretch ratios are as indicated in Table 17.

Example 14 is made from an 80/20 blend of Crystallizable PLA A and Non-Crystallizable PLA A.

Example 15 is made from a 60/40 blend of Crystallizable PLA A and Non-Crystallizable PLA A.

Example 16 is made from an 80/20 blend of Crystallizable PLA B and Non-Crystallizable PLA A.

Example 17 is made from a 60/40 blend of Crystallizable PLA B and Non-Crystallizable PLA A.

Shrinkage in both the machine and transverse directions is measured as before. Results are as indicated in Table 17. It is noted that crystallinity is at most slightly affected by annealing under the specified conditions. It appears that crystallinity develops almost entirely as a result of orientation that takes place during the stretching step.

TABLE 17

| | Stretch | | Annealing | | | |
|---|---|---|---|---|---|---|
| | Ratio | | Conditions | | Shrinkage | |
| Example | MD | TD | Temp., ° C. | Time, s | MD | TD |
| 14 | 3.5 | 5.5 | N/A | 0 | 17 | 38.5 |
| | | | 120 | 5 | 7 | 13 |
| | | | 120 | 30 | 7 | 8 |
| | | | 125 | 5 | 5 | 8 |
| | | | 125 | 30 | 3 | 6 |
| 15 | 3.5 | 7 | N/A | 0 | 8.5 | 39.5 |
| | | | 120 | 5 | 4 | 10 |
| | | | 120 | 30 | 3.5 | 12 |
| | | | 125 | 5 | 3 | 8.5 |
| | | | 125 | 30 | 2 | 7 |
| | | | 130 | 5 | 2.5 | 7 |
| | | | 130 | 30 | 2 | 4.5 |
| 16 | 3.5 | 5.5 | N/A | 0 | 22 | 47 |
| | | | 120 | 30 | 4.5 | 11 |
| | | | 125 | 5 | 4 | 10 |
| | | | 125 | 30 | 5 | 10.5 |
| | | | 135 | 5 | 2 | 6.5 |
| | | | 135 | 30 | 3 | 6 |
| | | | 145 | 5 | 2 | 2.5 |
| | | | 145 | 30 | 1.5 | 1.5 |
| 17 | 3.5 | 6.0 | N/A | 0 | 16.5 | 35.5 |
| | | | 120 | 30 | 3.5 | 8.5 |
| | | | 125 | 5 | 4 | 9 |
| | | | 125 | 30 | 3.5 | 7 |
| | | | 135 | 5 | 2.5 | 5.5 |
| | | | 135 | 30 | 2.5 | 4 |
| | | | 145 | 5 | 1 | 1.5 |
| | | | 145 | 30 | 1. | 1.5 |

### EXAMPLE 18

Cast sheets having a thickness of 650 to 800 μm are prepared from a 60/40 mixture of Crystallizable PLA A with Non-Crystallizable PLA B, in the general manner described before. The sheets are then sequentially stretched in the manner described in previous examples, at 80° C. and 85° C., to produce biaxially oriented films. Film properties are measured as before, with results as indicated in Table 18.

TABLE 18
Example 18 Biax Film Properties

Stretch Temperature, ° C.

| Property | 80° C. | 85° C. |
|---|---|---|
| Film Thickness, μm | 43 | 51 |
| Shrinkage, MD/TD, % | 4.5/8.5 | 3.5/8.5 |

1. A polylactide resin composition comprising a melt- or solution-blend of
(i) 40 to 95 weight percent based on the weight of all polylactides in the composition, of a crystallizable polylactide having a number-average molecular weight as measured by gel permeation chromatography against a polystyrene standard of at least 5000 g/mol and containing at least 90% by weight lactic units, wherein the lactic units are L-lactic units and D-lactic units in a ratio of ≥93:7 or ≤7:93, and
(ii) 60 to 5 weight percent based on the weight of all polylactides in the composition of a non-crystallizable polylactide having a number-average molecular weight as measured by gel permeation chromatography against a polystyrene standard of at least 5000 g/mol and containing at least 90% by weight lactic units, wherein the lactic units are L-lactic units and D-lactic units in a ratio of ≥20:80 or ≤80:20.

2. The polylactide resin composition of claim 1 which is phase segregated.

3. The polylactide resin composition of claim 2 wherein the non-crystallizable polylactide is present as a discontinuous amorphous phase dispersed within a continuous phase of the crystallizable polylactide.

4. The polylactide resin composition of claim 3 which contains 65 to 90 weight percent of the crystallizable polylactide, based on the weight of all polylactides in the composition, and 10 to 35 weight percent of the non-crystallizable polylactide, based on the weight of all polylactides in the composition.

5. The polylactide resin composition of claim 3 which contains 65 to 85 weight percent of the crystallizable polylactide, based on the weight of all polylactides in the composition, and 15 to 35 weight percent of the non-crystallizable polylactide, based on the weight of all polylactides in the composition.

6. The polylactide resin composition of claim 2 wherein the non-crystallizable polylactide and the crystallizable polylactide are present as co-continuous phases, the non-crystallizable phase being amorphous.

7. The polylactide resin composition of claim 6 which contains 55 to 64 weight percent of the crystallizable polylactide, based on the weight of all polylactides in the composition, and 45 to 36 weight percent of the non-crystallizable polylactide, based on the weight of all polylactides in the composition.

8. The polylactide resin composition of claim 1 which contains 55 to 64 weight percent of the crystallizable polylactide, based on the weight of all polylactides in the composition, and 45 to 36 weight percent of the non-crystallizable polylactide, based on the weight of all polylactides in the composition.

9. The polylactide resin composition of claim 1 wherein the non-crystallizable polylactide is poly(meso-lactide).

10. The polylactide resin composition of claim 1 in the form of a uniaxially or biaxially oriented film.

11. (canceled)

12. A process for producing an oriented polylactide film, comprising (a) forming a polylactide resin composition by melt- or solution-blending, the polylactide resin composition comprising
(i) 40 to 95 weight percent based on the weight of all polylactides in the composition, of a crystallizable polylactide having a number-average molecular weight as measured by gel permeation chromatography against a polystyrene standard of at least 5000 g/mol and containing at least 90% by weight lactic units, wherein the lactic units are L-lactic units and D-lactic units in a ratio of ≥93:7 or ≤7:93 and (ii) 60 to 5 weight percent based on the weight of all polylactides in the composition of a non-crystallizable polylactide having a number-average molecular weight as measured by gel permeation chromatography against a polystyrene standard of at least 5000 g/mol and containing at least 90% by weight lactic units, wherein the lactic units are L-lactic units and D-lactic units in a ratio of ≥20:80 or ≤80:20;
(b) extruding the polylactide resin composition through an extrusion die in a machine direction to produce a polylactide sheet, and
(c) stretching the sheet at a temperature of 50° C. to 120° C. to produce the oriented polylactide film.

13. (canceled)

14. A process for producing a biaxially oriented polylactide film, comprising (a) forming a polylactide resin composition by melt- or solution-blending, the polylactide resin composition comprising
(i) 40 to 95 weight percent based on the weight of all polylactides in the composition, of a crystallizable polylactide having a number-average molecular weight as measured by gel permeation chromatography against a polystyrene standard of at least 5000 g/mol and containing at least 95% by weight lactic units, wherein the lactic units are L-lactic units and D-lactic units in a ratio of ≥93:7 or ≤7:93 and (ii) 60 to 5 weight percent based on the weight of all polylactides in the composition of a non-crystallizable polylactide having a number-average molecular weight as measured by gel permeation chromatography against a polystyrene standard of at least 5000 g/mol and at least 90% by weight lactic units, and wherein the lactic units are L-lactic units and D-lactic units in a ratio of ≥20:80 or ≤80:20;
(b) extruding the polylactide resin composition through an extrusion die in a machine direction to produce a polylactide sheet having a machine direction corresponding to the direction of movement of the polylactide blend through the extrusion die, and an orthogonal transverse direction, and
(c) sequentially or simultaneously stretching the sheet in orthogonal directions at a temperature of 50° C. to 120° C. to produce the biaxially oriented polylactide film.

15. The process of claim 14 wherein in step (c) the sheet is stretched in a machine direction and an orthogonal transverse direction, the stretch ratio in the machine direction being 3 to 5 and the stretch ratio in the transverse direction being 4 to 9.

16. The process of claim 14 wherein in step (c) the sheet is stretched first in a machine direction at a temperature of 50° C. to 100° C. and subsequently stretched in an orthogonal transverse direction at a temperature of 70° C. to 120° C.

17. The process of claim 14 wherein the sheet is stretched at a stretch rate of 25% to 100% per second.

18-20. (canceled)
